(19) United States
(12) Patent Application Publication
(10) Pub. No.: US 2015/0070142 A1
(43) Pub. Date: Mar. 12, 2015

(54) REMOTE CONTROL SYSTEM, METHOD FOR CONFIGURING REMOTE CONTROL SYSTEM, COMMUNICATION TERMINAL DEVICE, ELECTRONIC DEVICE, AND SERVER DEVICE

(71) Applicant: Sharp Kabushiki Kaisha, Osaka-shi, Osaka (JP)

(72) Inventors: Kazuhiro Miki, Osaka-shi (JP); Masashi Matsumoto, Osaka-shi (JP); Masahiro Ueda, Osaka-shi (JP); Makio Tomita, Osaka-shi (JP); Toshio Akabane, Osaka-shi (JP); Hiroyuki Kishida, Osaka-shi (JP)

(21) Appl. No.: 14/385,242

(22) PCT Filed: Mar. 12, 2013
(86) PCT No.: PCT/JP2013/056757

§ 371 Date: Sep. 15, 2014

(30) Foreign Application Priority Data
May 7, 2012 (JP) 2012-106327

(51) Int. Cl. G08C 17/00

(52) U.S. Cl. CPC G08C 17/00; G08C 2201/60
USPC 340/12.22

(57) ABSTRACT

In a case where a registration process of registering a second mode is carried out, (i) a communication terminal device (10) transmits, to an electronic device (20), according to a first communication method, an access instruction which instructs the electronic device (20) to access a server device (50), (ii) the electronic device (20) accesses the server device (50) in response to the access instruction, and (iii), upon reception of the access from the electronic device (20), the server device (50) registers the communication terminal device (10) and the electronic device (20) associated with each other. This makes it possible to improve security of a remote control system.

### TECHNICAL FIELD

The present invention relates to (i) a remote control system in which an operation of an electronic device is remotely controlled by use of a communication terminal device, (ii) a method of configuring the remote control system, and (iii) the communication terminal device, the electronic device, and a server device which are used in the remote control system.

### BACKGROUND ART

A technique for controlling operations of various electronic devices via a communications network by use of a communication terminal device such as a mobile phone has been conventionally known.

For example, Patent Literature 1 describes that (i) an owner of a robot to be controlled carries out an owner registration on a server by use of a communication terminal device so as to obtain, from the server, data for a right to access the robot, (ii) the owner transfers the data to a communication terminal device of another person (guest), and (iii) the another person requests the server to authorize the another person to access the robot. Patent Literature 1 also describes that, in a case where the another person requests the server to authorize the another person to access the robot, the server notifies the communication terminal device of the owner that the another person has requested the server to authorize the another person to access the robot so that the server finds whether or not the another person is authorized to access the robot.

### CITATION LIST

### Patent Literature

Patent Literature 1
Japanese Patent Application Publication, Tokukai, No. 2005-184304 (Publication Date: Jul. 7, 2005)

### SUMMARY OF INVENTION

### Technical Problem

However, according to the technique of Patent Literature 1, for example, in a case where information (e.g., ID) necessary for an owner registration is leaked, there is a possibility that a third person carries out an unauthorized owner registration to carry out an unauthorized operation of a robot to be controlled.

The present invention was made in view of the problem, and an object of the present invention is to improve security of a remote control system in which an operation of an electronic device is controlled by use of a communication terminal device.

### Solution to Problem

A remote control system of the present invention is configured to be a remote control system that includes: a communication terminal device; an electronic device; and a server device, the communication terminal device and the electronic device communicating with each other according to a first communication method that is a communication method for establishing a communication between a device and another device that exists within a predetermined range, the server device communicating with the communication terminal device and the electronic device according to a second communication method that is a communication method for establishing a communication via a communications network between a device and another device that exists in a remote place, in a case where a registration process is carried out with respect to the communication terminal device to control an operation of the electronic device via the server device by use of the communication terminal device through a communication based on the second communication method, the communication terminal device transmitting, to the electronic device, according to the first communication method, an access instruction which instructs the electronic device to access the server device, in response to the access instruction, the electronic device accessing the server device according to the second communication method, and in response to the accessing from the electronic device, the server device registering the electronic device and the communication terminal device associated with each other as a combination of the communication terminal device and the electronic device which combination allows the operation of the electronic device to be controlled.

### Advantageous Effects of Invention

According to the remote control system of the present invention, it is possible to reduce a risk that a third person carries out an unauthorized registration process of registering the second mode, thereby improving security.

### BRIEF DESCRIPTION OF DRAWINGS

FIG. 1 is an explanatory view schematically illustrating a configuration of a remote control system of an embodiment of the present invention.

FIG. 2 is a perspective view of an electronic device (self-propelled vacuum cleaner) included in the remote control system illustrated in FIG. 1.

FIG. 3 is a plain view illustrating a configuration of a bottom surface of the electronic device (self-propelled vacuum cleaner) illustrated in FIG. 2.

FIG. 4 is a flowchart illustrating a flow of processes for registering a second mode which are carried out by a communication terminal device included in the remote control system illustrated in FIG. 1.

FIG. 5 is a flowchart illustrating a flow of processes for registering the second mode which are carried out by the electronic device included in the remote control system illustrated in FIG. 1.

FIG. 6 is a flowchart illustrating a flow of processes for registering the second mode which are carried out by a server device included in the remote control system illustrated in FIG. 1.

FIG. 7 is an explanatory view illustrating an example of registration information of a first mode and the second mode which registration information is stored in a storage section of the communication terminal device included in the remote control system illustrated in FIG. 1.

FIG. 8 is an explanatory view illustrating an example of registration information of the first mode and the second mode which registration information is stored in a storage section of the electronic device included in the remote control system illustrated in FIG. 1.

FIG. 9 is an explanatory view illustrating an example of registration information of the second mode which registration information is stored in a storage section of the server device included in the remote control system illustrated in FIG. 1.

### DESCRIPTION OF EMBODIMENTS

The following description will discuss an embodiment of the present invention.

(1-1. Outline of Remote Control System 100)

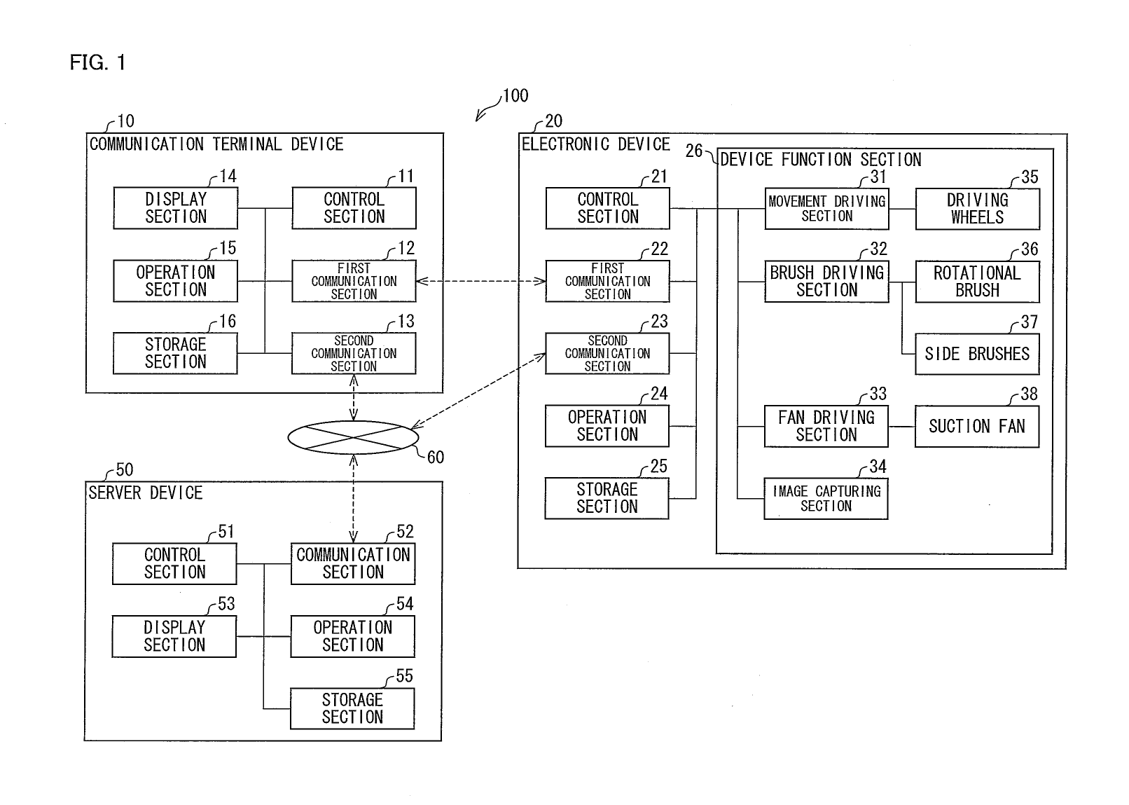

FIG. 1 is an explanatory view schematically illustrating a configuration of a remote control system 100 (electronic device controlling system) of the present embodiment. As illustrated in FIG. 1, the remote control system 100 includes a communication terminal device 10, an electronic device 20, and a server device 50. The communication terminal device 10, the electronic device 20, and the server device 50 are connected so as to communicate with one another via a communications network 60. The communication terminal device 10 and the electronic device 20 are further configured to be communicable with each other without the communications network 60. Note that the number of electronic devices 20 included in the remote control system 100 is not limited to one. The remote control system 100 may include a plurality of electronic devices 20. Similarly, the number of communication terminal devices 10 included in the remote control system 100 is neither limited to one. The remote control system 100 may include a plurality of communication terminal devices 10.

As illustrated in FIG. 1, the communication terminal device 10 includes a control section 11, a first communication section 12, a second communication section 13, a display section 14, an operation section 15, and a storage section 16. Note that the communication terminal device 10 is not limited to a specific one provided that it includes the first communication section 12 and the second communication section 13 (later described). Examples of the communication terminal device 10 include a smart phone, a tablet terminal, a mobile phone, a PDA (Personal Digital Assistance), a laptop personal computer, and a mobile video game machine.

The control section 11 is control means, of the communication terminal device 10, for controlling an operation of each of the sections of the communication terminal device 10. The control section 11 is constituted by a computer device that includes, for example, (i) a computation section such as a CPU or a dedicated-purpose processor and (ii) a storage section such as a RAM, a ROM or an HDD (none of which is illustrated). The control section 11 controls the operation of each of the sections of the communication terminal device 10 by (i) reading, from the storage section, various pieces of information and programs for executing various controls and (ii) executing the programs.

The first communication section 12 is communication means (short-distance communication means) for establishing a communication according to a communication method (first communication method) for establishing a communication between a device and another device that exists within a predetermined range (communicable range). The first communication section establishes a mutual communication between the communication terminal device 10 and another device such as the electronic device 20 which is arranged within the predetermined range. Assume that the first communication section 12 of the present embodiment is a WiFi (Registered Trademark) device which mutually connects wireless devices to each other on the basis of a wireless LAN standard, i.e., IEEE802.11 (IEEE802.11a or IEEE802.11b). Note, however, that a configuration of the first communication section 12 is not limited to this. For example, the first communication section 12 may establish a communication based on another wireless LAN standard, other than IEEE802.11, such as a short-distance wireless communication standard (e.g., Bluetooth (Registered Trademark) or ZigBee (Registered Trademark)). Alternatively, the first communication section 12 may establish a communication by means of infrared radiation.

The second communication section 13 is communication means for establishing a communication according to a communication method (second communication method) for establishing a communication via the communications network 60 between a device and another device that exits in a remote place. The second communication section 13 establishes a communication between the communication terminal device 10 and another device such as the server device 50 which is connected so as to communicate with the communication terminal device 10 via the communications network 60. The communications network 60 is not limited to a specific one provided that it provides a communicable range wider than that by the communication method for use in the first communication section 12. Examples of the communications network 60 include the Internet, telephone line network, mobile communications network, CATV communications network, and satellite communications network. Assume that the second communication section 13 of the present embodiment communicates with another device via the Internet. Moreover, HTTP (Hypertext Transfer Protocol) or HTTPS (Hypertext Transfer Protocol over Secure Socket Layer) is used to establish a communication of the second communication section 13 of the present embodiment according to the second communication method.

The display section 14 displays various pieces of information for a user in accordance with an instruction of the control section 11. A configuration of the display section 14 is not limited to a specific one. Examples of the display section 14 include a liquid crystal display panel, an organic EL panel, and a plasma display panel.

The operation section 15 receives an operation input from a user, and notifies the control section 11 of the operation input. A configuration of the operation section 15 is not limited to a specific one. For example, the operation section 15 may include key operation buttons, or may be a touch panel or a combination of the key operation buttons and the touch panel.

The storage section 16 is storage means for storing various pieces of information used in the communication terminal device 10. A configuration of the storage section 16 is not limited to a specific one. A conventionally publicly-known storage medium can be used as the storage section 16.

The electronic device 20 functions to operate in accordance with a control instruction from the communication terminal device 10. The present embodiment will mainly describe a case where the electronic device 20 is a self-propelled vacuum cleaner. A configuration of the electronic device 20 is not limited to this provided that the electronic device 20 functions to operate in accordance with a control instruction from the communication terminal device 10. Examples of the electronic device 20 include an air cleaning device, a water heater, an air conditioning device, an image shooting device, various pieces of audio-visual equipment, and various robots (such as a housework assistance robot and an animal-shaped robot).

As illustrated in FIG. 1, the electronic device 20 includes a control section 21, a first communication section 22, a second communication section 23, an operation section 24, a storage section 25, and a device function section 26.

The control section 21 is control means, of the electronic device 20, for controlling an operation of each of the sections of the electronic device 20. The control section 21 is constituted by a computer device that includes, for example, (i) a computation section such as a CPU or a dedicated-purpose processor and (ii) a storage section such as a RAM, a ROM or an HDD (none of which is illustrated). The control section 21 controls the operation of each of the sections of the electronic device 20 by (i) reading, from the storage section, various pieces of information and programs for executing various controls and (ii) executing the programs.

The first communication section 22 (first communication means) is communication means (short-distance communication means) for establishing a communication according to a communication method (first communication method) for establishing a communication between a device and another device that exists within a predetermined range (communicable range). The first communication section 22 establishes a mutual communication between the electronic device 20 and another device such as the communication terminal device 10 which is arranged within the predetermined range. The first communication section 22 can be configured in the same manner as the configuration of the first communication section 12 included in the communication terminal device 10.

The second communication section 23 (second communication means) is communication means for communicating via the communications network 60 with another device such as the server device 50. Any of the above-described configurations can be employed as the communications network 60.

The operation section 24 receives an instruction input from a user, and notifies the control section 21 of the instruction input. A configuration of the operation section 24 is not limited to a specific one. For examples, the operation section 24 may include key operation buttons, or may be a touch panel or a combination of the key operation buttons and the touch panel.

The storage section 25 is storage means for storing various pieces of information used in the electronic device 20. A configuration of the storage section 25 is not limited to a specific one. Examples of the storage section 25 include various RAMs, ROMs, and HDDs.

The device function section 26 carries out a device function of the electronic device 20 in accordance with an instruction of the control section 21. For example, in a case where the electronic device 20 is a self-propelled vacuum cleaner, the device function section 26 carries out functions such as a running function and a cleaning function (dust collecting function). Alternatively, in a case where the electronic device 20 is a device such as an air clearing device, a water heater, an air conditioning device, an image shooting device, various pieces of audio-visual equipment, or various robots, the device function section 26 carries out a corresponding device function (e.g., an air cleaning function, a hot water supply function, an air conditioning function, an image shooting function, or a moving function) of the device.

Since the electronic device 20 of the present embodiment is a self-propelled vacuum cleaner, the device function section 26 includes a movement driving section 31, a brush driving section 32, a fan driving section 33, an image capturing section 34, driving wheels 35, a rotational brush 36, side brushes 37, and a suction fan 38 (see FIG. 1).

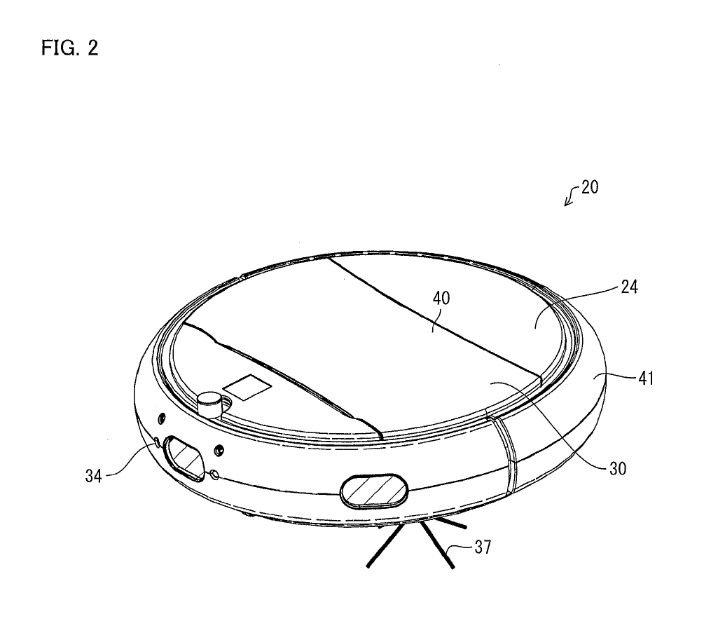

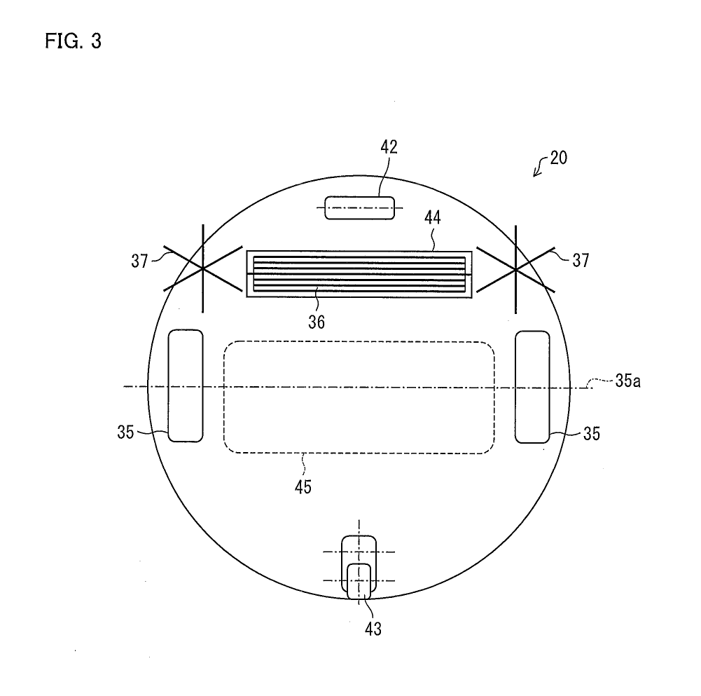

FIG. 2 is a perspective view of the electronic device 20 (self-propelled vacuum cleaner) of the present embodiment. FIG. 3 is a plain view of a bottom surface (a surface which faces a floor) of the self-propelled vacuum cleaner.

As illustrated in FIG. 2, the self-propelled vacuum cleaner (electronic device 20) of the present embodiment includes a substantially disk-shaped housing 30, the operation section 24, and a lid part 40. The operation section 24 and the lid part 40 are provided in an upper part of the housing 30. The lid part 40 is openable and closable about the housing 30. By opening the lid part 40, it is possible to detach a dust collecting container (not illustrated) from the housing 30, so that dust in the dust collecting container can be discarded.

The housing 30 has a side surface on which a bumper 41 is provided so as to alleviate an impact made on the housing 30 when the housing 30 collides with a wall etc. The bumper 41 has a hole part where the image capturing section 34 is provided.

The image capturing section 34 shoots a moving image and/or a static image in accordance with an instruction of the control section 21. A configuration of the image capturing section 34 is not limited to a specific one. Conventionally publicly-known image capturing means can be employed as the image capturing section 34. For example, image capturing means which includes, e.g., an optical lens, a color filter, and a CCD (Charge Coupled Device) that is a light receiving element can be employed as the image capturing section 34. Note that, in addition to or instead of the image capturing section 34, the electronic device may include an audio acquiring section (not illustrated) for acquiring audio around the electronic device 20.

As illustrated in FIG. 3, the housing 30 has a bottom surface where the driving wheels 35, a front wheel 42, a rear wheel 43, the rotational brush 36, the side brushes 37, and a suction port 44 are provided.

The driving wheels 35 are provided on respective opposite end sides of a center line 35a on the bottom surface of the housing 30 which bottom surface is circular. These driving wheels 35 are provided so as to partially protrude from the bottom surface of the housing 30 and so as to rotate around respective rotation shafts (not illustrated) parallel to the center line 35a. These rotation shafts are driven to rotate by the movement driving section 31 constituted by, e.g., a motor or a gear (not illustrated). This causes the driving wheels 35 to rotate. That is, the movement driving section 31 drives the rotation shifts to rotate by using electric power supplied from a battery (not illustrated) in response to an instruction of the control section 21. This causes the driving wheels 35 to rotate, thereby allowing the electronic device 20 (self-propelled vacuum cleaner) to carry out self-propulsion on a floor surface. Note that the driving wheels 35 are configured to be individually driven to rotate. In a case where these driving wheels 35 are driven to rotate in a same direction, the electronic device 20 moves forward or backward in a rotational direction of the driving wheels 35. In contrast, in a case where these driving wheels 35 are driven to rotate in respective opposite directions, the electronic device 20 rotates on the spot in parallel with the bottom surface in accordance with each rotational direction of the driving wheels 35. This configuration allows the electronic device 20 to clean while changing a movement direction, avoiding an obstacle, and uniformly moving within a predetermined cleaning region. Note that the electronic device 20 (self-propelled vacuum cleaner) may be configured to include a sensor (not illustrated) for sensing that the bumper 41 has collided with a wall etc. as a result of a movement of the electronic device 20. With this configuration, when the sensor senses that the bumper 41 has collided with a wall etc., the control section 21 controls the electronic device 20 to change the movement direction so that the electronic device 20 can keep moving. Alternatively, the electronic device 20 may be configured to detect an obstacle such as a wall on the basis of an image-capturing result brought by the image capturing section 34 so that the electronic device 20 can move while avoiding the obstacle.

The suction port 44 is a rectangular concave part which is dent from the bottom surface of the housing 30 toward an inner part of the housing 30. In the concave part of the suction port 44 provided is the rotational brush 36 which rotates around a rotation shaft parallel to the bottom surface of the housing 30. The side brushes 37 are provided in the vicinity of respective opposite end sides of the suction port 44 in a long-side direction of the suction port 44. The side brushes 37 rotate around respective rotation shafts perpendicular to the bottom surface of the housing 30. The brush driving section 32 drives the rotation shafts of the rotational brush 36 and the side brushes 37 to rotate, by using electric power supplied from a battery (secondary battery) (not illustrated) in response to an instruction of the control section 21. This causes the rotational brush 36 and the side brushes 37 to rotate. In other words, the brush driving section 32 drives the rotational brush 36 and the side brushes 37 to rotate. Moreover, the fan driving section 33 drives the suction fan 38. This causes dust around the brushes to be sucked into the suction port 44. The concave part of the suction port 44 is partially communicated with the dust collecting container in a dust collecting section 45. Dust etc. sucked into the suction port 44 is collected in the dust collecting container.

The front wheel 42, having a roller shape, is provided on one end side in a direction perpendicular to the center line 35a on the bottom surface of the housing 30 so as to rotate in a rotational direction identical to those of the driving wheels 35. The rear wheel 43 is provided on the other end side in the direction perpendicular to the center line 35a on the bottom surface of the housing 30 so that a direction of a rotation shaft of the rear wheel 43 is flexibly changeable in parallel with the bottom surface of the housing 30. The front wheel 42 is configured so that, in a case where the housing 30 is arranged on a flat floor, the front wheel 42 is away from the floor while the driving wheels 35, the rear wheel 43, the rotational brush 36, and the side brushes 37 are in contact with the floor. With this configuration, it is possible to suck, into the suction port 44, dust ahead of and in the movement direction of the electronic device 20 without the front wheel 42 disturbing the suction of the dust into the suction port 44. Moreover, the electronic device 20 (self-propelled vacuum cleaner) can easily get over a step in the movement direction, by the front wheel 42 coming into contact with the step.

The server device 50 includes a control section 51, a communication section 52, a display section 53, an operation section 54, and a storage section 55 (see FIG. 1).

The control section 51 is control means, of the server device 50, for controlling an operation of each of the sections of the server device 50. The control section 51 is constituted by a computer device that includes, for example, (i) a computation section such as a CPU or a dedicated-purpose processor and (ii) a storage section such as a RAM, a ROM or an HDD (none of which is illustrated). The control section 51 controls the operation of each of the sections of the server device 50 by (i) reading, from the storage section, various pieces of information and programs for executing various controls and (ii) executing the programs.

The communication section 52 (second communication means) is communication means for communicating via the communications network 60 with another device. Any of the above-described configurations can be employed as the communications network 60.

The display section 53 displays various pieces of information for a manager of the server device 50 in accordance with an instruction of the control section 51. A configuration of the display section 53 is not limited to a specific one. Examples of the display section 53 include a liquid crystal display panel, an organic EL panel, and a plasma display panel.

The operation section 54 receives an operation input from the manager of the server device 50, and notifies the control section 51 of the operation input. A configuration of the operation section 54 is not limited to a specific one. For example, the operation section 54 may include key operation buttons, or may be a touch panel or a combination of the key operation buttons and the touch panel.

The storage section 55 is storage means for storing various pieces of information used in the remote control system 100. A configuration of the storage section 55 is not limited to a specific one. Examples of the storage section 55 include various RAMs, ROMs, and HDDs.

Note that the remote control system 100 of the present embodiment has (i) a first mode (at-home mode, indoor mode) and (ii) a second mode (out-of-home mode, outdoor mode). In the first mode, the first communication section 12 transmits a control command to the electronic device 20 according to the first communication method, the control command corresponding to an instruction input which a user of the communication terminal device 10 has entered via the operation section 15, so that an operation of the electronic device 20 is controlled in accordance with the control command. In the second mode, the second communication section 13 transmits a control command to the server device 50 via the communications network 60 according to the second communication method, the control command corresponding to an instruction input which a user of the communication terminal device 10 has entered via the operation section 15, and then the server device 50 transfers the control command to the electronic device 20 via the communications network 60 according the second communication method, so that the operation of the electronic device 20 is controlled in accordance with the control command.

According to the present embodiment, in order to cause the electronic device 20 to operate in the first mode, it is necessary to carry out in advance a registration process of registering the first mode on the communication terminal device 10 and the electronic device 20, i.e., a (pairing) process of storing (registering), in the storage section 16 of the communication terminal device 10 and in the storage section 25 of the electronic device 20, a combination (pair) of the electronic device 20 and the communication terminal device 10 which are associated with each other, the combination allowing an operation control to be carried out in the first mode.

Further, according to the present embodiment, the registration process of registering the first mode on the communication terminal device 10 and the electronic device 20 includes a process of operating at least one of a predetermined operation button of the operation section 15 of the communication terminal device 10 and a predetermined operation button of the operation section 24 of the electronic device 20 while a communication is being established according to the first communication method between the first communication section 12 of the communication terminal device 10 and the first communication section 22 of the electronic device 20. In order to carry out the registration process of registering the first mode, a person who has the communication terminal device 10 needs to carry out the registration process in the vicinity of the electronic device 20 (in a place where the communication terminal device 10 and the electronic device 20 are communicable with each other according to the first communication method). It is therefore possible to prevent or constrain a third person who is not authorized to control the operation of the electronic device 20 from carrying out an unauthorized registration process of registering the first mode.

The registration process of registering the first mode on the communication terminal device 10 and the electronic device 20 may include a process of simultaneously operating a predetermined operation button of the operation section 15 of the communication terminal device 10 and a predetermined operation button of the operation section 24 of the electronic device 20 while a communication is being established according to the first communication method between the first communication section 12 of the communication terminal device 10 and the first communication section 22 of the electronic device 20. In this case, in order to carry out the registration process of registering the first mode, a person who has the communication terminal device 10 needs to carry out the registration process in a place close to the electronic device 20 in which place (i) the communication terminal device 10 and the electronic device 20 are communicable with each other according to the first communication method and (ii) the person can simultaneously operate the operation section 15 of the communication terminal device 10 and the operation section 24 of the electronic device 20. It is therefore possible to more surely prevent or constrain a third person who is not authorized to control the operation of the electronic device 20 from carrying out an unauthorized registration process of registering the first mode.

In order to cause the electronic device 20 to operate in the second mode, it is necessary to carry out a registration process of registering the second mode on the server device 50, the communication terminal device 10, and the electronic device 20. That is, it is necessary to carry out in advance a process of storing (registering), in the storage section 55 of the server device 50, in the storage section 16 of the communication terminal device 10, and in the storage section 25 of the electronic device 20, a combination (pair) of the electronic device 20 and the communication terminal device 10, the combination allowing an operation control to be carried out in the second mode.

According to the present embodiment, the registration process of registering the second mode can be carried out only for a combination of the communication terminal device 10 and the electronic device 20 with respect to which combination the registration process of registering the first mode has been already carried out. Further, the registration process of registering the second mode on the server device 50, the communication terminal device 10, and the electronic device 20 includes carrying out a predetermined operation on the operation section 15 of the communication terminal device 10 while (i) a communication is being established according the first communication method between the first communication section 12 of the communication terminal device 10 and the first communication section 22 of the electronic device 20, (ii) a communication is being established according to the second communication method via the communications network 60 between the second communication section 13 of the communication terminal device 10 and the communication section 52 of the server device 50, and (iii) a communication is being established according to the second communication method via the communications network 60 between the second communication section 23 of the electronic device 20 and the server device 50. The registration process of registering the second mode will be later described in detail.

(1-2. Registration Process of Registering Second Mode)

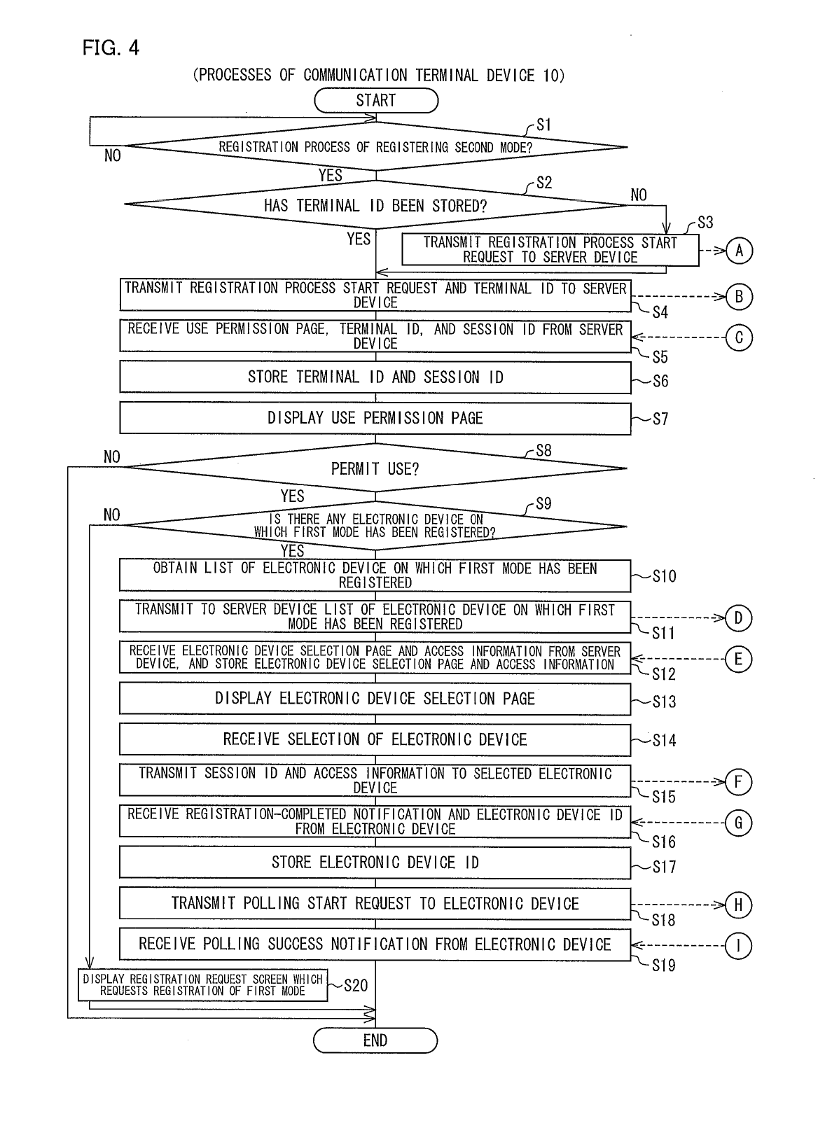

The following description will discuss a registration process of registering the second mode, with reference to FIGS. 4 through 9.

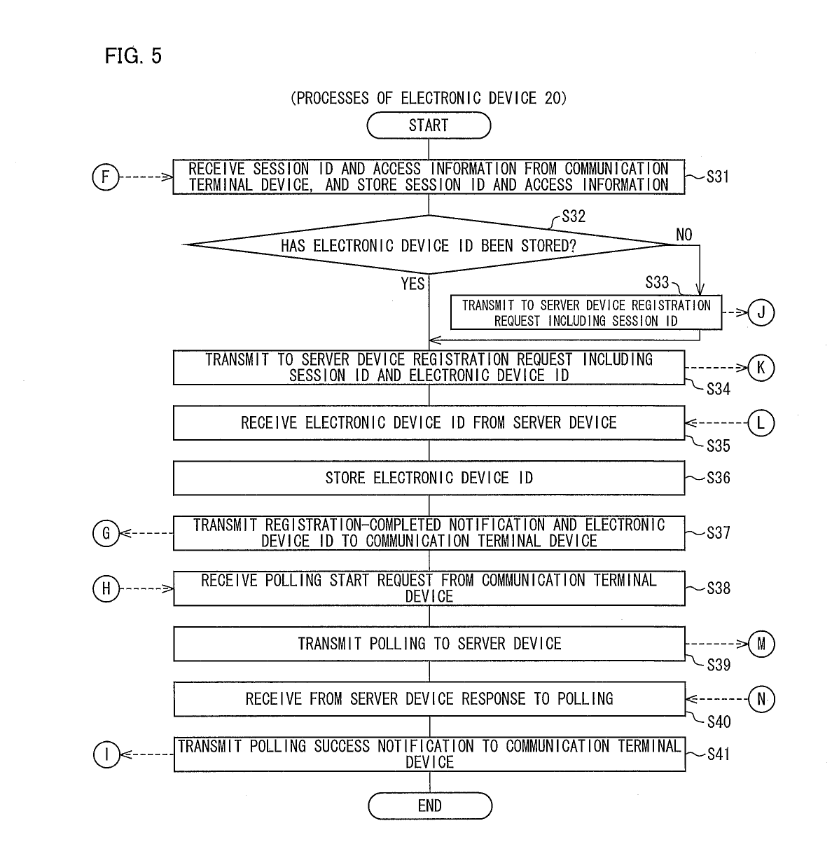

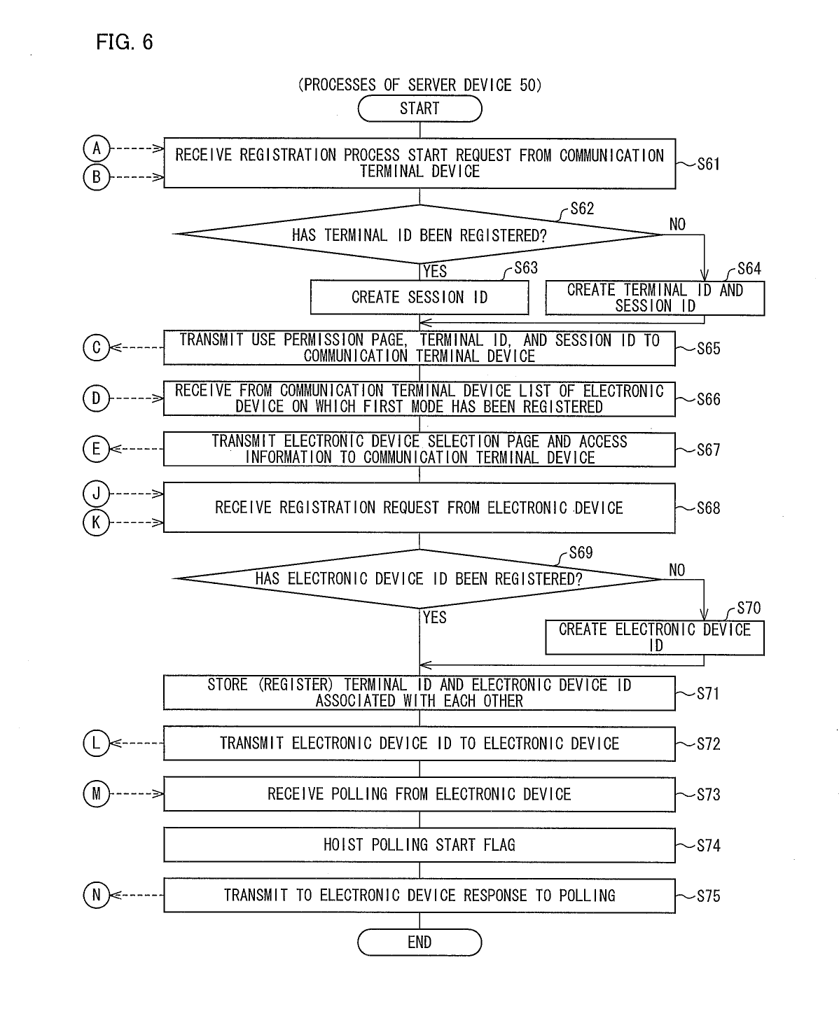

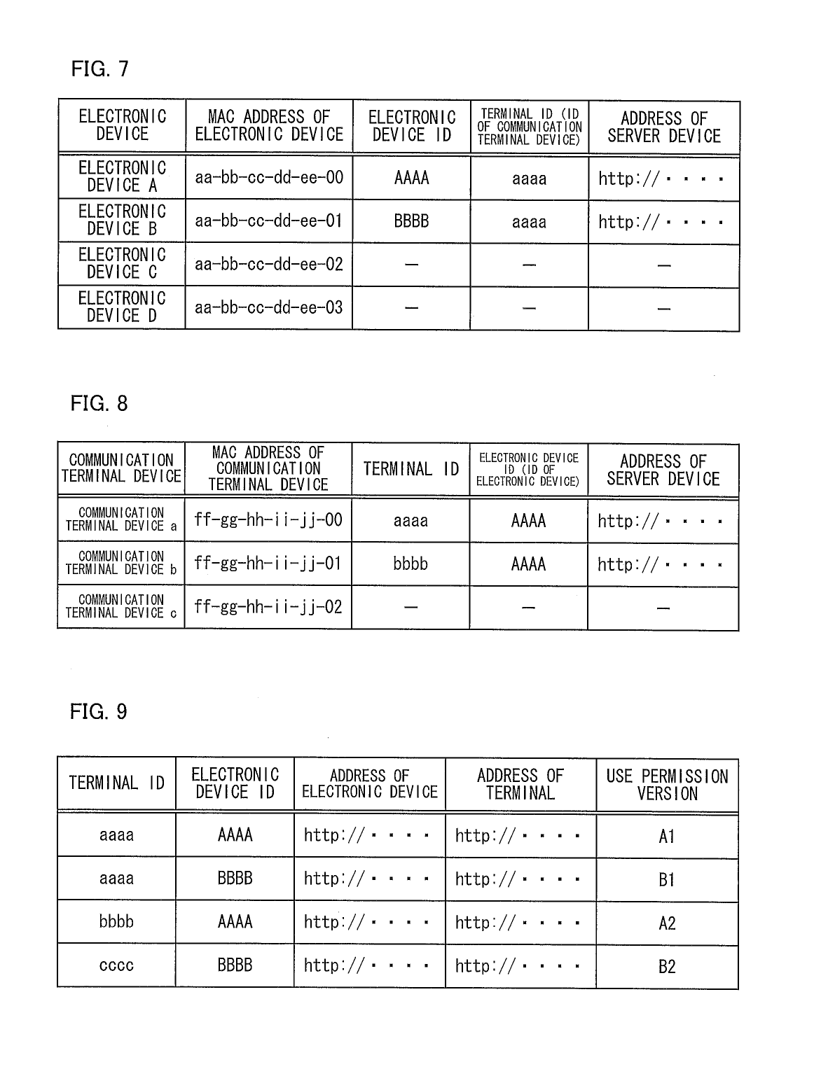

FIG. 4 is a flowchart illustrating processes for registering the second mode which are carried out by the communication terminal device 10. FIG. 5 is a flowchart illustrating processes for registering the second mode which are carried out by the electronic device 20. FIG. 6 is a flowchart illustrating processes for registering the second mode which are carried out by the server device 50. FIG. 7 is an explanatory view illustrating an example of registration information of the first mode and the second mode which registration information is stored in the storage section 16 of the communication terminal device 10. FIG. 8 is an explanatory view illustrating an example of registration information of the first mode and the second mode which registration information is stored in the storage section 25 of the electronic device 20. FIG. 9 is an explanatory view illustrating an example of registration information of the second mode which registration information is stored in the storage section 55 of the server device 50.

In the example illustrated in FIG. 7, electronic devices A through D are registered on the communication terminal device 10 as an electronic device whose operation is controllable in the first mode by use of the communication terminal device 10. The electronic devices A and B are further registered as an electronic device whose operation is controllable in the second mode. The electronic devices A through D registered as the electronic device whose operation is controllable in the first mode have respective pieces of address information (such as MAC address (Media Access Control address)) based on each of which the communication terminal device 10 communicates with a corresponding one of the electronic devices A through D according to the first communication method. The pieces of address information are registered so as to be associated with the respective electronic devices A through D. Each of the electronic devices A and B registered as the electronic device whose operation is controllable in the second mode has its electronic device ID given by the server device 50. Registered are (i) the electronic device ID, (ii) address information of the server device 50 to which the second communication section 13 transmits, via the communications network 60, according to the second communication method, a control command for controlling an operation of the each of the electronic devices A and B, and (iii) an terminal ID of the communication terminal device 10 which terminal ID is given by the server device 50, the electronic device ID, the address information, and the terminal ID being associated with the each of the electronic devices A and B.

In the example illustrated in FIG. 8, communication terminal devices a through c are registered on the electronic device 20 as a communication terminal device which receives a control command in the first mode. The communication terminal devices a and b are further registered on the electronic device 20 as a communication terminal device which receives a control command in the second mode. The communication terminal devices a through c registered as the communication terminal device which receives a control command in the first mode have respective pieces of address information (such as MAC address) based on each of which the first communication section 22 establishes a communication between the electronic device 20 and a corresponding one of the communication terminal devices a through c. The pieces of address information are registered so as to be associated with the respective communication terminal devices a through c. Each of the communication terminal devices a and b registered as the communication terminal device which receives a control command in the second mode has its terminal ID given by the server device 50. Registered are (i) the terminal ID, (ii) the address information of the server device 50 which the second communication section 23 accesses via the communications network 60 according to the second communication method so as to receive a control command from the each of the communication terminal devices a and b, and (iii) an electronic device ID of the electronic device 20 which electronic device ID is given by the server device 50, the terminal ID, the address information, and the electronic device ID being associated with the each of the communication terminal devices a and b.

In the example illustrated in FIG. 9, (i) a pair of the communication terminal device a (terminal ID: aaaa) and the electronic device A (electronic device ID: AAAA), (ii) a pair of the communication terminal device a (terminal ID: aaaa) and the electronic device B (electronic device ID: BBBB), (iii) a pair of the communication terminal device b (terminal ID: bbbb) and the electronic device A (electronic device ID: AAAA), and (iv) a pair of the communication terminal device c (terminal ID: cccc) and the electronic device B (electronic device ID: BBBB) are registered on the server device 50 as a combination (pair) of a communication terminal device and an electronic device which combination allows an operation control to be carried out in the second mode. The communication terminal device and the electronic device of which the combination is registered have respective pieces of address information based on which the communication section 52 communicates via the communications network 60 according to the second communication method with the communication terminal device and the electronic device. The respective pieces of address information are registered. For each of the pairs is registered use permission version information indicative of a version (old or new) of a permission of a use of a corresponding one of the electronic devices A and B.

As illustrated in FIG. 4, the control section 11 of the communication terminal device 10 determines whether or not a predetermined operation for starting a registration process of registering the second mode has been carried out (for example, whether a predetermined button (e.g., “out-of-home mode button”) for starting the registration process of registering the second mode has been pressed (S1).

In a case where the control section 11 determines in S1 that the predetermined operation has not been carried out, the control section 11 keeps monitoring whether or not the predetermined operation is carried out. In contrast, in a case where the control section 11 determines in S1 that the predetermined operation has been carried out, the control section 11 determines whether or not a terminal ID (identification information) of the communication terminal device 10 which terminal ID is given by the server device 50 is stored in the storage section 16 (S2).

In a case where the control section 11 determines in S2 that the terminal ID is not stored in the storage section 16, the control section 11 controls the second communication section 13 to transmit a registration process start request to the server device 50 via the communications network 60 (S3).

In contrast, in a case where the control section 11 determines in S2 that the terminal ID is stored in the storage section 16, the control section 11 controls the second communication section 13 to transmit a registration process start request and the terminal ID (the terminal ID of the communication terminal device 10 which terminal ID is given by the server device 50) to the server device 50 via the communications network 60 (S4).

Note that the communication terminal device 10 is configured such that information (e.g., URL) of a device to which the registration process start request is transmitted in response to the predetermined operation is stored in advance in the storage section 16. In response to the predetermined operation, the control section 11 starts up a browser module (not illustrated) included in the communication terminal device 10, and controls the second communication section 13 to transmit the registration process start request to the server device 50 on the basis of the information of the device.

When the communication section 52 receives the registration process start request from the communication terminal device 10 (S61), the control section 51 of the server device 50 determines whether or not the terminal ID of the communication terminal device 10 is registered (S62). For example, in a case where data transmitted from the communication terminal device 10 to the server device 50 contains a terminal ID, the control section 51 determines whether or not the terminal ID is stored in the storage section 55 of the server device 50. In a case where the control section 51 determines that the terminal ID is stored in the storage section 55 of the server device 50, the control section 51 determines that the terminal ID of the communication terminal device 10 is registered. In contrast, in a case where (i) the data contains no terminal ID and (ii) a terminal ID received from the communication terminal device 10 is not stored in the storage section 55, the control section 51 determines that the terminal ID of the communication terminal device 10 is not registered.

In a case where the control section 51 determines in S62 that the terminal ID of the communication terminal device 10 is registered, the control section 51 creates a session ID (identification information) for this registration process of registering the second mode, and controls the storage section 55 to store the session ID (S63). Note that the session ID is a one-time ID which is applied to only a series of communication processes for this registration process of registering the second mode.

In contrast, in a case where the control section 51 determines in S62 that the terminal ID of the communication terminal device 10 is not registered, the control section 51 creates (i) the session ID (identification information) for this registration process of registering the second mode and (ii) the terminal ID of the communication terminal device 10, and controls the storage section 55 to store the session ID and the terminal ID of the communication terminal device 10 (S64).

The control section 51 then controls the communication section 52 to transmit, via the communications network 60, to the communication terminal device 10, (i) the session ID for this registration process of registering the second mode, (ii) the terminal ID of the communication terminal device 10, and (iii) page data of a use permission page (S65).

When the communication terminal device 10 receives, from the server device 50, the session ID, the terminal ID, and the page data of the use permission page (S5), the control section 11 of the communication terminal device 10 controls the storage section 16 to store the terminal ID and the session ID (S6). Note that it is preferable to cause the storage section 16 to store these IDs in such a manner that security which prevents these IDs from being leaked is secured. In order to secure the security, it is possible to cause the storage section 16 to store these IDs, for example, by use of SecureCookie.

The control section 11 also controls the display section 14 to display the use permission page based on the page data of the use permission page (S7).

The control section 11 then determines whether to permit use of the second mode, in accordance with an instruction entered via the operation section 15 by a user (in accordance with an input instruction concerning whether to permit a registration of the electronic device 20 as an electronic device whose operation is controlled in the second mode) (S8). Alternatively, the control section 51 of the server device 50 or the control section 21 of the electronic device 20 may determine, on the basis of a result of a user identification process, whether to permit the use of the second mode.

In a case where the control section 11 determines in S8 not to permit the use of the second mode, the control section 11 ceases and terminates the registration process of registering the second mode.

In contrast, in a case where the control section 11 determines in S8 to permit the use of the second mode, the control section 11 determines whether or not there is any electronic device with respect to which a registration process of registering the first mode has been carried out, that is, whether or not there is an electronic device whose operation is controllable in the first mode which electronic device is stored (registered) in advance in the storage section 16 (S9).

In a case where the control section 11 determines in S9 that there is no electronic device with respect to which a registration process of registering the first mode has been carried out, the control section 11 controls the display section 14 to display a registration request screen which requests a registration of the first mode (e.g., a screen including a message that it is necessary to carry out the registration process of registering the first mode before the registration process of registering the second mode) (S20), and then terminates the registration process of registering the second mode. That is, according to the present embodiment, as has been described, the registration process of registering the second mode can be carried out with respect to only a combination (pair) of a communication terminal device and an electronic device with respect to which combination the registration process of registering the first mode has been carried out. Therefore, in a case where there is no such combination, the control section ceases the registration process of registering the second mode, controls the display section 14 to display the registration request screen, and terminates the registration process of registering the second mode. Note that it may be configured so that the control section 11 of the communication terminal device 10 (i) notifies the server device 50 that there is no electronic device with respect to which a registration process of registering the first mode has been carried out and (ii) controls the display section 14 to display a registration request screen based on screen data of the registration request screen which requests a registration of the first mode which screen data is transmitted from the server device 50 in response to the notification.

In contrast, in a case where the control section 11 determines in S9 that there is an electronic device(s) with respect to which a registration process of registering the first mode has been carried out, the control section 11 obtains a list of the electronic device(s) with respect to which the registration process of registering the first mode has been carried out (S10). For example, the control section 11 may obtain the list by reading a list of an electronic device(s) whose operation(s) is/are controllable in the first mode which list is stored (registered) in the storage section 16. Alternatively, the control section 11 may (i) read information indicative of an electronic device whose operation is controllable in the first mode which information is stored (registered) in the storage section 16 and (ii) create, on the basis of the information, a list of an electronic device(s) with respect to which a registration process of registering the first mode has been carried out. Alternatively, the control section 11 may obtain the list of the electronic device(s) with respect to which the registration process of registering the first mode has been carried out, by starting up and executing a program (list request I/F) for obtaining the list of the electronic device(s) with respect to which the registration process of registering first mode has been carried out which program is created by use of, e.g., JavaScript (Registered Trademark).

The control section 11 then controls the second communication section 13 to transmit, via the communications network 60, to the server device 50, (i) the list of the electronic device(s) with respect to which the registration process of registering the first mode has been carried out and (ii) the terminal ID of the communication terminal device 10 (S11).

When the server device 50 receives, from the communication terminal device 10, the list of the electronic device(s) with respect to which the registration process of registering the first mode has been carried out (S66), the control section 51 of the server device 50 (i) creates page data of an electronic device selection page for selecting, from the electronic device(s) on the list, an electronic device with respect to which the registration process of registering the second mode is to be carried out and (ii) controls the communication section 52 to transmit, via the communications network 60, to the communication terminal device 10, the page data and access information indicative of where the electronic device 20 accesses so as to request a registration of the second mode (S67). When S66 is carried out, the control section 51 also hoists a use permission flag stored in the storage section 55. That is, the control section 51 changes a value of the use permission flag to a value showing that it has been permitted (approved) that a user controls an operation of the electronic device 20 in the second mode by use of the communication terminal device 10, with respect to each of which the electronic device 20 and the communication terminal device 10 the registration process of registering the second mode is to be carried out.

When the communication terminal device 10 receives, from the server device 50, (i) the page data of the electronic device selection page and (ii) the access information indicative of where the electronic device 20 accesses so as to request the registration of the second mode, the control section 11 of the communication terminal device 10 controls the storage section 16 to store the page data and the access information (S12).

The control section 11 then controls the display section 14 to display the electronic device selection page based on the page data of the electronic device selection page which page data is received from the server device 50 (S13).

The control section 11 receives, via the operation section 15, a user's instruction which instructs to select an electronic device 20 with respect to which the registration process of registering the second mode is to be carried out (S14). The control section 11 then controls the first communication section 12 to transmit, to the electronic device 20 selected by the user in S14, (i) the session ID received from the server device 50 in S5 and (ii) the access information received from the server device 50 in S12 (S15).

When a first communication section 22 of the electronic device 20 selected by the user receives the session ID and the access information from the communication terminal device 10, a control section 21 of the electronic device 20 selected by the user controls a storage section 25 of the electronic device 20 selected by the user to store the session ID and the access information (S31).

The control section 21 of the electronic device 20 selected by the user determines whether an electronic device ID which the server device 50 gives to the electronic device 20 selected by the user is stored or not (S32). That is, according to the present embodiment, in a case where a registration process of registering the second mode has been carried out with respect to an electronic device 20, the server device 50 notifies the electronic device 20 of an electronic device ID which the server device 50 gives to the electronic device 20. In response to the notification, the electronic device 20 stores the electronic device ID in a storage section 25 of the electronic device 20 (later described). The control section 21 of the electronic device 20 selected by the user determines in S32 whether or the electronic device ID of the electronic device 20 selected by the user is stored in advance in the storage section 25 of the electronic device 20 selected by the user, i.e., whether or not a registration process of registering the second mode has been carried out with respect to the electronic device 20 selected by the user.

In a case where the control section 21 of the electronic device 20 selected by the user determines in S32 that the electronic device ID is not stored, the control section 21 of the electronic device 20 selected by the user accesses a place indicated by the access information received in S31 so as to transmit, to the place, a registration request including the session ID (S33).

In contrast, in a case where the control section 21 of the electronic device 20 selected by the user determines in S32 that the electronic device ID is stored, the control section 21 of the electronic device 20 selected by the user transmits, to the place indicated by the access information received in S31, a registration request including the session ID and the electronic device ID of the electronic device 20 selected by the user (S34).

Note that, in a case where an operation of the electronic device 20 selected by the user is controlled in the second mode, HTTPS may be used to establish a communication between the communication terminal device 10 and the server device 50 and/or a communication between the server device 50 and the electronic device 20 selected by the user. In a case where HTTPS is used, the registration request may be used to carry out a time setting necessary for a communication based on HTTPS.

When the server device 50 receives the registration request from the electronic device 20 selected by the user (S68), the control section 51 of the server device 50 determines whether or not a registration process of registering the second mode has been carried out with respect to the electronic device 20 selected by the user (S69). For example, in a case where the registration request received from the electronic device 20 selected by the user includes an electronic device ID, the control section 51 determines whether or not the electronic device ID is stored in the storage section 55 of the server device 50. In a case where the control section 51 determines that the electronic device ID is stored in the storage section 55 of the server device 50, the control section 51 determines that the electronic device ID of the electronic device 20 selected by the user is registered in the second mode. In contrast, in a case where (i) the registration request received from the electronic device 20 selected by the user includes no electronic device ID and (ii) an electronic device ID received from the electronic device 20 selected by the user is not stored in the storage section 55, the control section 51 determines that the electronic device ID of the electronic device 20 selected by the user is not registered.

In a case where the control section 51 determines in S69 that the electronic device 20 which transmitted the registration request to the server device 50 is not registered, the control section 51 creates the electronic device ID of the electronic device 20 (S70).

In contrast, in a case where the control section 51 determines in S69 that the electronic device 20 which transmitted the registration request to the server device 50 is registered, the control section 51 creates, in S70, the electronic device ID of the electronic device 20, and then controls the storage section 55 to store (register) the electronic device ID of the electronic device 20 and the terminal ID of the communication terminal device 10, the electronic ID and the terminal ID being associated (paired) with each other (S71).

The control section 51 then controls the communication section 52 to transmit, via the communications network 60, to the electronic device 20 which transmitted the registration request to the server device 50, the electronic device ID created for (given to) the electronic device 20 (S72).

When the electronic device 20 receives, from the server device 50, the electronic device ID given to the electronic device 20 (S35), the control section 21 of the electronic device 20 controls the storage section 25 to store the electronic device ID (S36).

The control section 21 further controls the first communication section 22 to transmit, to the communication terminal device 10, the electronic device ID of the electronic device 20 and a registration-completed notification (pairing success notification) which notifies the communication terminal device 10 that the registration process of registering the second mode has been carried out with respect to the server device 50 (S37).

When the first communication section 12 of the communication terminal device 10 receives the registration-completed notification and the electronic device ID from the electronic device 20 (S16), the control section 11 of the communication terminal device 10 controls the storage section 16 to store the electronic device ID (S17). The control section 11 then controls the first communication section 12 to transmit a polling start request to the electronic device 20 (S18).

When the first communication section 22 of the electronic device 20 receives the polling start request from the communication terminal device 10 (S38), the control section 21 of the electronic device 20 controls a second communication section 23 of the electronic device 20 to poll the server device 50 via the communications network 60 (S39). Note that an address of a device to be polled may be an address to which the registration request is transmitted in S34 or an address different from the address to which the registration request is transmitted. In a case where the address of the device to be polled is the address different from the address to which the registration request is transmitted, for example, the server device 50 transmits the address of the device to be polled to the electronic device 20 together with the electronic device ID in S72, and the electronic device 20 stores in the storage section 25 the address of the device to be polled.

When the communication section 52 of the server device 50 is polled by the electronic device 20 (S73), the control section 51 of the server device 50 hoists a polling start flag (not illustrated) stored in the storage section 55 (S74). That is, the control section 51 changes a value of the polling start flag to a value showing that the electronic device 20 has started polling. The control section 51 then controls the communication section 52 to transmits, via the communications network 60, to the electronic device 20, a response to the polling (S75).

When the second communication section 23 of the electronic device 20 receives, from the server device 50, the response to the polling (S40), the control section 21 of the electronic device 20 controls the first communication section 22 to transmit, to the communication terminal device 10, a polling success notification which notifies the communication terminal device 10 that the polling has successfully started (S41).

When the first communication section 12 of the communication terminal device 10 receives the polling success notification from the electronic device 20 (S19), the control section 11 of the communication terminal device 10 determines that the registration process of registering the second mode on the electronic device 20 has been normally carried out, and completes the registration process of registering the second mode.

(1-3. Controlling Operation of Electronic Device 20 in Second Mode)

In a case where an operation of the electronic device 20 is controlled in the second mode by use of the communication terminal device 10 after the registration process of registering the second mode is completed, a user of the communication terminal device 10 operates a predetermined button of the operation section 15 of the communication terminal device 10. In response to the user's operation, the control section 11 of the communication terminal device 10 controls the second communication section 13 to transmit, via the communications network 60, to the server device 50, a second-mode use start request that includes the terminal ID of the communication terminal device 10 and the electronic device ID of the electronic device 20 whose operation is to be controlled.

When the server device 50 receives the second-mode use start request from the communication terminal device 10, the control section 51 of the server device 50 determines whether to permit controlling the operation of the electronic device 20 in the second mode by use of the communication terminal device 10, by (i) finding a use permission flag of the communication terminal device 10 (finding whether or not the user permits controlling the operation of the electronic device 20 in the second mode) and (ii) confirming a use permission version (confirming whether there is a newer use permission or not).

In a case where the control section 51 determines to permit the controlling, the control section 51 confirms a status of the electronic device 20 to be controlled (finds whether to transmit a polling start instruction), and controls the communication section 52 to transmit the polling start instruction to the electronic device 20, if necessary. In accordance with the polling start instruction, the electronic device 20 starts a polling for polling the server device 50 every predetermined time whether or not there is data to be transmitted to the electronic device 20.

The control section 51 further controls the communication section 52 to transmit, via the communications network 60, to the communication terminal device 10, operation screen data for operating in the second mode. Upon reception of the operation screen data, the communication terminal device 10 causes the display section 14 to display an operation screen based on the operation screen data. Information indicative of details of a user's operation on the displayed operation screen is transmitted to the server device 50.

The control section 51 of the server device 50 (i) creates, on the basis of the information received from the communication terminal device 10, transmission data including a control command for the electronic device 20, and (ii) controls the storage section 55 to temporarily store the transmission data. In a case where the server device 50 is polled by the electronic device 20 after the transmission data is created, the server device transmits the transmission data to the electronic device 20. This causes the operation of the electronic device 20 to be controlled via the server device 50 by use of the communication device 10.

(1-4. Effect Brought About by Remote Control System 100)

As such, the remote control system 100 of the present embodiment is configured as follows: In a case where a registration process of registering the second mode is carried out with respect to a communication terminal device 10 and an electronic device 20, the communication terminal device 10 transmits, to the electronic device 20, according to the first communication method (a communication method for establishing a communication between a device and another device that exists within a predetermined range), an access instruction which instructs the electronic device 20 to access the server device 50. Upon reception of the access instruction, the electronic device 20 accesses the server device 50 according to the second communication method. In response to the access from the electronic device 20, the server device 50 registers the electronic device 20 and the communication terminal device 10 which are associated with each other as a combination of the electronic device 20 and the communication terminal device 10 which combination allows an operation control to be carried out in the second mode.

According to the configuration, in order to carry out the registration process of registering the second mode, it is necessary to establish a communication according to the first communication method between the communication terminal device and the electronic device. Since the first communication method is the communication method for establishing a communication between a device and another device that exists within a predetermined range, a user who has the communication terminal device should carry out, in the vicinity of the electronic device (within the predetermined range), the registration process of registering the second mode so as to establish the communication according to the first communication method between the communication terminal device and the electronic device. It is therefore possible to reduce a risk that a third person carries out an unauthorized registration process of registering the second mode, thereby improving security.

The remote control system 100 of the present embodiment is further configured as follows: In the case where the registration process of registering the second mode is carried out with respect to the communication terminal device 10 and the electronic device 20, the communication terminal device 10 transmits, to the server device 50, according to the second communication method (a communication method for establishing a communication via the communications network 60), a list of an electronic device(s) 20 with respect to which a registration process of registering the first mode has been carried out so as to be associated with the communication terminal device 10. Upon reception of the list, the server device 50 transmits, to the communication terminal device 10, according to the second communication method, selection request screen data (selection request information) for allowing a user to select, from the list, the electronic device 20 with respect to which the registration process of registering the second mode is to be carried out. The communication terminal device 10 (i) receives a user's selection instruction which instructs to select, on a selection request screen, the electronic device 20 with respect to which the registration process of registering the second mode is to be carried out, and (ii) transmits the access instruction to the electronic device 20 selected by the user.

According the configuration, in order to carry out the registration process of registering the second mode, it is necessary to associate the communication terminal device 10 and the electronic device 20 with each other in advance by carrying out the registration process of registering the first mode. It is therefore possible to further reduce a risk that a third person carries out an unauthorized registration process of registering the second mode, thereby further improving security.

Further, in order to carry out the registration process of registering the second mode, it is necessary that a communication can be established (i) according to the second communication method between the communication terminal device and the server device and (ii) according to the second communication method between the electronic device and the server device. It is therefore possible to, by carrying out the registration process of registering the second mode, find that a communication can be established which communication is required to control the operation of the electronic device in the second mode.

Note that details of an operation control of the electronic device 20 in the second mode by use of the communication terminal device 10 are not particularly limited provided that the device function of the electronic device 20 is utilized.

Examples of the device function to be utilized include (i) a function, of the image capturing section 34 of the electronic device 20, of capturing an image (a moving image or a static image) around the electronic device 20, (ii) a function of transmitting, via the server device 50, to the communication terminal device 10, image data of an image which is captured by the image capturing section 34, (iii) a function of storing, in a predetermined holder of the server device 50 (or another device connected to the communications network 60), image data of an image captured by the image capturing section 34, and (iv) a function, of the electronic device 20, of running (carrying out self-propulsion) and collecting dust (cleaning).

As has been described, the electronic device 20 is not limited to a self-propelled vacuum cleaner. Examples of the electronic device 20 include an air cleaning device, a water heater, an air conditioning device, an image shooting device, various pieces of audio-visual equipment, and various robots (such as a housework assistance robot and an animal-shaped robot). Therefore, the operation control may be control of device functions of these electronic devices.

It may be configured in the present embodiment so that some pieces of or all of (i) data to be transmitted or received between the communication terminal device 10 and the server device 50, (ii) data to be transmitted or received between the electronic device 20 and the server device 50, and (iii) data to be transmitted or received between the communication terminal device 10 and the electronic device 20 are encrypted. For example, HTTPS is used to encrypt these pieces of data.

According to the present embodiment, no limitation is placed on the number of communication terminal devices 10 to be registered so as to be associated with a single electronic device 20 in a registration process of registering the second mode. Alternatively, a limitation may be placed on the number of communication terminal devices 10 to be registered so as to be associated with a single electronic device 20. In a case where (i) the limitation is placed on the number of communication terminal devices 10 to be registered so as to be associated with a single electronic device 20, (ii) the registration process of registering the second mode is requested to be carried out, and (iii) the limitation is exceeded, the control section 51 of the server device 50 may (1) refuse a new registration of a communication terminal device 10, (2) cancel a registration of a communication terminal device 10 which has been registered for a longest period of time, and newly register a communication terminal device 10, (3) give in advance an order of priority to each communication terminal device 10, cancel a registration of a communication terminal device 10 having a lowest priority, and newly register a communication terminal device 10 or (4) cause a user to select a communication terminal device 10 whose registration should be cancelled, cancel the registration of the selected communication terminal device 10, and newly register a communication terminal device 10.

Each of the control section 11 of the communication terminal device 10, the control section 21 of the electronic device 20, and the control section 51 of the server device 50 of the present embodiment may be realized by software as executed by a processor such as a CPU. In this case, each of the communication terminal device 10, the electronic device 20, and the server device 50 includes: a CPU (Central Processing Unit) that executes instructions of a control program that realizes each function; a ROM (Read Only Memory) storing the control program; and a RAM (Random Access Memory) that develops the control program; and a storage device (storage medium) such as a memory which stores the control program and various kinds of data. The object of the present invention can be achieved, by mounting to the each of the communication terminal device 10, the electronic device 20, and the server device 50, a computer-readable storage medium storing a program code of the control program (executable program, intermediate code program, or source program) for the each of the communication terminal device 10, the electronic device 20, and the server device 50, the control program being software for realizing the foregoing functions, so that the computer (or CPU or MPU) retrieves and executes the program code stored in the storage medium.

The storage medium can be, for example, a tape, such as a magnetic tape or a cassette tape; a disk including (i) a magnetic disk such as a Floppy (Registered Trademark) disk or a hard disk and (ii) an optical disk such as CD-ROM, MO, MD, DVD, or CD-R; a card such as an IC card (memory card) or an optical card; or a semiconductor memory such as a mask ROM, EPROM, EEPROM (Registered Trademark), or flash ROM.

Alternatively, the each of the communication terminal device 10, the electronic device 20, and the server device 50 can be arranged to be connectable to a communications network so that the program code is made available to the each of the communication terminal device 10, the electronic device 20, and the server device 50 via the communications network. The communications network is not limited to a specific one, and therefore can be, for example, the Internet, Intranet, extranet, LAN, ISDN, VAN, CATV communications network, virtual dedicated network (virtual private network), telephone line network, mobile communications network, or satellite communications network. The transfer medium which constitutes the communications network is not limited to a specific one, and therefore can be, for example, wired line such as IEEE 1394, USB, electric power line, cable TV line, telephone line, or ADSL line; or wireless such as infrared radiation (IrDA, remote control), Bluetooth (Registered Trademark), 802.11 wireless, HDR (High Data Rate), mobile telephone network, satellite line, or terrestrial digital network. Note that the present invention can also be implemented by the program code in the form of a computer data signal embedded in a carrier wave which is embodied by electronic transmission.

Each block of the each of the communication terminal device 10, the electronic device 20, and the server device 50 is not limited to being realized by software, but may be configured by, for example, a hardware logic or may be realized by a combination of (i) hardware which partially carries out a process and (ii) computation means which executes software which carries out control of the hardware and a residual process.

A remote control system of the present invention is configured to be a remote control system that includes: a communication terminal device; an electronic device; and a server device, the communication terminal device and the electronic device communicating with each other according to a first communication method that is a communication method for establishing a communication between a device and another device that exists within a predetermined range, the server device communicating with the communication terminal device and the electronic device according to a second communication method that is a communication method for establishing a communication via a communications network between a device and another device that exists in a remote place, in a case where a registration process is carried out with respect to the communication terminal device to control an operation of the electronic device via the server device by use of the communication terminal device through a communication based on the second communication method, the communication terminal device transmitting, to the electronic device, according to the first communication method, an access instruction which instructs the electronic device to access the server device, in response to the access instruction, the electronic device accessing the server device according to the second communication method, and in response to the accessing from the electronic device, the server device registering the electronic device and the communication terminal device associated with each other as a combination of the communication terminal device and the electronic device which combination allows the operation of the electronic device to be controlled.

A method, of the present invention, of configuring a remote control system is configured to be a method of configuring a remote control system that includes a communication terminal device, an electronic device, and a server device, the communication terminal device and the electronic device communicating with each other according to a first communication method that is a communication method for establishing a communication between a device and another device that exists within a predetermined range, the server device communicating with the communication terminal device and the electronic device according to a second communication method that is a communication method for establishing a communication via a communications network between a device and another device that exists in a remote place, the method including the steps of: in a case where a registration process is carried out with respect to the communication terminal device to control an operation of the electronic device via the server device by use of the communication terminal device through a communication based on the second communication method, causing the communication terminal device to transmit, to the electronic device, according to the first communication method, an access instruction which instructs the electronic device to access the server device; causing the electronic device to access the server device according to the second communication method in response to the access instruction; and causing the server device to register, in response to the accessing from the electronic device, the electronic device and the communication terminal device associated with each other as a combination of the communication terminal device and the electronic device which combination allows an operation control to be carried out in a second mode.

A communication terminal device of the present invention is configured to be a communication terminal device for use in a remote control system that includes the communication terminal device, an electronic device, and a server device, the communication terminal device and the electronic device communicating with each other according to a first communication method that is a communication method for establishing a communication between a device and another device that exists within a predetermined range, the server device communicating with the communication terminal device and the electronic device according to a second communication method that is a communication method for establishing a communication via a communications network between a device and another device that exists in a remote place, in a case where a registration process is carried out with respect to the electronic device to control an operation of the electronic device via the server device by use of the communication terminal device through a communication based on the second communication method, the communication terminal device transmitting, to the electronic device, according to the first communication method, an access instruction which instructs the electronic device to access the server device.

An electronic device of the present invention is configured to be an electronic device for use in a remote control system that includes the electronic device, a communication terminal device, and a server device, the electronic device and the communication terminal device communicating with each other according to a first communication method that is a communication method for establishing a communication between a device and another device that exists within a predetermined range, the server device communicating with the communication terminal device and the electronic device according to a second communication method that is a communication method for establishing a communication via a communications network between a device and another device that exists in a remote place, in a case where a registration process is carried out to control an operation of the electronic device via the server device by use of the communication terminal device through a communication based on the second communication method, the electronic device (i) receiving, from the communication terminal device, an access instruction which instructs the electronic device to access the server device, and (ii) accessing the server device according to the second communication method in response to the access instruction.

A server device of the present invention is configured to be a server device for use in a remote control system that includes the server device, a communication terminal device, and an electronic device, the communication terminal device and the electronic device communicating with each other according to a first communication method that is a communication method for establishing a communication between a device and another device that exists within a predetermined range, the server device communicating with the communication terminal device and the electronic device according to a second communication method that is a communication method for establishing a communication via a communications network between a device and another device that exists in a remote place, in a case where a registration process is carried out with respect to the communication terminal device to control an operation of the electronic device via the server device by use of the communication terminal device through a communication based on the second communication method, upon reception of an access made according to the second communication method by the electronic device, the server device registering the electronic device and the communication terminal device associated with each other as a combination of the communication terminal device and the electronic device which combination allows the operation of the electronic device to be controlled.

According to the remote control system, the method of configuring the remote control system, the communication terminal device, the electronic device, and the server device, in order to carry out a registration process of registering the second mode, it is necessary to establish a communication according to the first communication method between the communication terminal device and the electronic device. Since the first communication method is the communication method for establishing a communication between a device and another device that exists within a predetermined range, a user who has the communication terminal device should carry out, in the vicinity of the electronic device (within the predetermined range), the registration process of registering the second mode, so as to establish the communication according to the first communication method between the communication terminal device and the electronic device. It is therefore possible to reduce a risk that a third person carries out an unauthorized registration process of registering the second mode, thereby improving security.

The remote control system may be configured so that the remote control system has (i) a first mode in which the operation of the electronic device is controlled by use of the communication terminal device through a communication based on the first communication method and (ii) a second mode in which the operation of the electronic device is controlled via the server device by use of the communication terminal device through the communication based on the second communication method, the operation of the electronic device is controllable in the first mode between the communication terminal device and the electronic device which are associated with each other in advance by carrying out a registration process of registering the first mode, the operation of the electronic device is controllable in the second mode between the communication terminal device and the electronic device which are associated with each other in advance by carrying out a registration process of registering the second mode, in a case where the registration process of registering the second mode is carried out with respect to the communication terminal device and the electronic device, the communication terminal device transmits, to the server device, according to the second communication method, a list of the electronic device which is associated with the communication terminal device in advance by carrying out the registration process of registering the first mode, the server device transmits, to the communication terminal device, according to the second communication method, selection request information for causing a user to select the electronic device from the list, and the communication terminal device transmits the access instruction to the electronic device selected on the basis of the selection request information by the user.

According to the configuration, in order to carry out the registration process of registering the second mode on the communication terminal device and the electronic device, it is necessary to associate the communication terminal device and the electronic device with each other in advance by carrying out the registration process of registering the first mode. Therefore, even in a case where information necessary for a registration of the second mode is leaked, it is not possible to carry out the registration of the second mode on an electronic device with respect to which a registration of the first mode has not been carried out. It is therefore possible to reduce a risk that a third person carries out an unauthorized registration process of registering the second mode, thereby improving security.

The remote control system may be configured so that the first communication method is (i) a communication method employing a wireless LAN, (ii) a communication method based on a short-distance wireless communication standard or (iii) a communication method employing infrared radiation. Examples of the communication method employing the wireless LAN include a communication method for establishing a mutual communication between wireless devices on the basis of IEEE802.11 (IEEE802.11a or IEEE802.11b). That is, each of the communication terminal device and the electronic device may be a WiFi (Registered Trademark) device. Examples of the short-distance wireless communication standard include Bluetooth (Registered Trademark) and ZigBee (Registered Trademark).

The remote control system may be configured so that the server device carries out a registration process of registering a second mode on the communication terminal device and the electronic device, by (i) creating respective pieces of identification information of the communication terminal device and the electronic device and (ii) storing these pieces of identification information associated with each other, in response to the accessing from the electronic device, the server device determines whether or not the registration process of registering the second mode has been carried out with respect to a combination of the electronic device and another communication terminal device different from the communication terminal device, in a case where the server device determines that the registration process of registering the second mode has been carried out with respect to the combination, the server device registers the electronic device and the communication terminal device as a combination of the communication terminal device and the electronic device which combination allows an operation control to be carried out in the second mode, by storing (i) the piece of identification information of the electronic device and (ii) the piece of identification information created for the communication terminal device such that these pieces of identification information are associated with each other.

According to the configuration, it is possible to register a plurality of communication terminal devices for a single electronic device as communication terminal devices by use of which an operation of the single electronic device is controllable in the second mode. Further, it is possible to easily manage registration information because the plurality of communication terminal devices can share identification information of the single electronic device though the plurality of communication terminal devices are associated with the single electronic device.

The remote control system may be configured so that the registration process of registering the first mode is carried out with respect to the communication terminal device by a user's predetermined operation which is carried out with respect to both (i) an operation section of the communication terminal device and (ii) an operation section of the electronic device, the user's predetermined operation being carried out while a communication is being established according to the first communication method between the communication terminal device and the electronic device.

According to the configuration, in order to carry out the registration process of registering the first mode, a user who has the communication terminal device needs to carry out the registration process of registering the second mode in a place close to the electronic device in which place the communication terminal device and the electronic device are communicable with each other according to the first communication method. It is therefore possible to reduce a risk that a third person carries out an unauthorized registration process of registering the first mode, thereby improving security.

The present invention is not limited to the description of the embodiment above, and can therefore be modified by a skilled person in the art within the scope of the claims. Namely, an embodiment derived from a proper combination of technical means disclosed in different embodiments is encompassed in the technical scope of the present invention.

### INDUSTRIAL APPLICABILITY

The present invention is applicable to (i) a remote control system in which an operation of an electronic device is controlled via a communications network by use of a communication terminal device, and (ii) the communication terminal device, the electronic device, and a server device which are used in the remote control system.

### REFERENCE SIGNS LIST

10: Communication terminal device
11: Control section
12: First communication section
13: Second communication section
14: Display section
15: Operation section
16: Storage section
20: Electronic device
21: Control section
22: First communication section
23: Second communication section
24: Operation section
25: Storage section
26: Device function section
50: Server device
51: Control section
52: Communication section
53: Display section
54: Operation section
55: Storage section
60: Communications network (Wide-area communications network)
100: Remote control system

1. A remote control system, comprising:
a communication terminal device;
an electronic device; and
a server device,
the communication terminal device and the electronic device communicating with each other according to a first communication method that is a communication method for establishing a communication between a device and another device that exists within a predetermined range,
the server device communicating with the communication terminal device and the electronic device according to a second communication method that is a communication method for establishing a communication via a communications network between a device and another device that exists in a remote place,
in a case where a registration process is carried out with respect to the communication terminal device to control an operation of the electronic device via the server device by use of the communication terminal device through a communication based on the second communication method,
the communication terminal device transmitting, to the electronic device, according to the first communication method, an access instruction which instructs the electronic device to access the server device,
in response to the access instruction, the electronic device accessing the server device according to the second communication method, and
in response to the accessing from the electronic device, the server device registering the electronic device and the communication terminal device associated with each other as a combination of the communication terminal device and the electronic device which combination allows the operation of the electronic device to be controlled.

2. The remote control system as set forth in claim 1, wherein the remote control system has (i) a first mode in which the operation of the electronic device is controlled by use of the communication terminal device through a communication based on the first communication method and (ii) a second mode in which the operation of the electronic device is controlled via the server device by use of the communication terminal device through the communication based on the second communication method,
the operation of the electronic device is controllable in the first mode between the communication terminal device and the electronic device which are associated with each other in advance by carrying out a registration process of registering the first mode,
the operation of the electronic device is controllable in the second mode between the communication terminal device and the electronic device which are associated with each other in advance by carrying out a registration process of registering the second mode,
in a case where the registration process of registering the second mode is carried out with respect to the communication terminal device and the electronic device,
the communication terminal device transmits, to the server device, according to the second communication method, a list of the electronic device which is associated with the communication terminal device in advance by carrying out the registration process of registering the first mode,
the server device transmits, to the communication terminal device, according to the second communication method, selection request information for causing a user to select the electronic device from the list, and
the communication terminal device transmits the access instruction to the electronic device selected on the basis of the selection request information by the user.

3. The remote control system as set forth in claim 1, wherein the first communication method is (i) a communication method employing a wireless LAN, (ii) a communication method based on a short-distance wireless communication standard or (iii) a communication method employing infrared radiation.

4. The remote control system as set forth in claim 1, wherein the server device carries out a registration process of registering a second mode on the communication terminal device and the electronic device, by (i) creating respective pieces of identification information of the communication terminal device and the electronic device and (ii) storing these pieces of identification information associated with each other,
in response to the accessing from the electronic device, the server device determines whether or not the registration process of registering the second mode has been carried out with respect to a combination of the electronic device and another communication terminal device different from the communication terminal device,
in a case where the server device determines that the registration process of registering the second mode has been carried out with respect to the combination, the server device registers the electronic device and the communication terminal device as a combination of the communication terminal device and the electronic device which combination allows an operation control to be carried out in the second mode, by storing (i) the piece of identification information of the electronic device and (ii) the piece of identification information created for the communication terminal device such that these pieces of identification information are associated with each other.

5. The remote control system as set forth in claim 2, wherein the registration process of registering the first mode is carried out with respect to the communication terminal device by a user's predetermined operation which is carried out with respect to at least one of (i) an operation section of the communication terminal device and (ii) an operation section of the electronic device, the user's predetermined operation being carried out while a communication is being established according to the first communication method between the communication terminal device and the electronic device.

6. A method of configuring a remote control system that includes a communication terminal device, an electronic device, and a server device, the communication terminal device and the electronic device communicating with each other according to a first communication method that is a communication method for establishing a communication between a device and another device that exists within a predetermined range, the server device communicating with the communication terminal device and the electronic device according to a second communication method that is a communication method for establishing a communication via a communications network between a device and another device that exists in a remote place,
the method comprising the steps of:
in a case where a registration process is carried out with respect to the communication terminal device to control an operation of the electronic device via the server device by use of the communication terminal device through a communication based on the second communication method,
causing the communication terminal device to transmit, to the electronic device, according to the first communication method, an access instruction which instructs the electronic device to access the server device;
causing the electronic device to access the server device according to the second communication method in response to the access instruction; and
causing the server device to register, in response to the accessing from the electronic device, the electronic device and the communication terminal device associated with each other as a combination of the communication terminal device and the electronic device which combination allows an operation control to be carried out in a second mode.

7. A communication terminal device for use in a remote control system that includes the communication terminal device, an electronic device, and a server device, the communication terminal device and the electronic device communicating with each other according to a first communication method that is a communication method for establishing a communication between a device and another device that exists within a predetermined range, the server device communicating with the communication terminal device and the electronic device according to a second communication method that is a communication method for establishing a communication via a communications network between a device and another device that exists in a remote place,
in a case where a registration process is carried out with respect to the electronic device to control an operation of the electronic device via the server device by use of the communication terminal device through a communication based on the second communication method,
the communication terminal device transmitting, to the electronic device, according to the first communication method, an access instruction which instructs the electronic device to access the server device.

8. The communication terminal device as set forth in claim 7, wherein the remote control system has (i) a first mode in which the operation of the electronic device is controlled by use of the communication terminal device through a communication based on the first communication method and (ii) a second mode in which the operation of the electronic device is controlled via the server device by use of the communication terminal device through the communication based on the second communication method,
the operation of the electronic device is controllable in the first mode between the communication terminal device and the electronic device which are associated with each other in advance by carrying out a registration process of registering the first mode,
the operation of the electronic device is controllable in the second mode between the communication terminal device and the electronic device which are associated with each other in advance by carrying out a registration process of registering the second mode,
in a case where the registration process of registering the second mode is carried out with respect to the electronic device,
the communication terminal device (i) transmits, to the server device, according to the second communication method, a list of the electronic device which is associated with the communication terminal device in advance by carrying out the registration process of registering the first mode, (ii) receives selection request information for causing a user to select the electronic device from the list, the selection request information being transmitted to the communication terminal device according to the second communication method by the server device upon reception of the list, and (iii) transmits the access instruction to the electronic device selected on the basis of the selection request information by the user.

9. An electronic device for use in a remote control system that includes the electronic device, a communication terminal device, and a server device, the electronic device and the communication terminal device communicating with each other according to a first communication method that is a communication method for establishing a communication between a device and another device that exists within a predetermined range, the server device communicating with the communication terminal device and the electronic device according to a second communication method that is a communication method for establishing a communication via a communications network between a device and another device that exists in a remote place,
in a case where a registration process is carried out to control an operation of the electronic device via the server device by use of the communication terminal device through a communication based on the second communication method,
the electronic device (i) receiving, from the communication terminal device, an access instruction which instructs the electronic device to access the server device, and (ii) accessing the server device according to the second communication method in response to the access instruction.

10. A server device for use in a remote control system that includes the server device, a communication terminal device, and an electronic device, the communication terminal device and the electronic device communicating with each other according to a first communication method that is a communication method for establishing a communication between a device and another device that exists within a predetermined range, the server device communicating with the communication terminal device and the electronic device according to a second communication method that is a communication method for establishing a communication via a communications network between a device and another device that exists in a remote place,
in a case where a registration process is carried out with respect to the communication terminal device to control an operation of the electronic device via the server device by use of the communication terminal device through a communication based on the second communication method,
upon reception of an access made according to the second communication method by the electronic device, the server device registering the electronic device and the communication terminal device associated with each other as a combination of the communication terminal device and the electronic device which combination allows the operation of the electronic device to be controlled.

11. The server device as set forth in claim 10, wherein the remote control system has (i) a first mode in which the operation of the electronic device is controlled by use of the communication terminal device through a communication based on the first communication method and (ii) a second mode in which the operation of the electronic device is controlled via the server device by use of the communication terminal device through the communication based on the second communication method,
the operation of the electronic device is controllable in the first mode between the communication terminal device and the electronic device which are associated with each other in advance by carrying out a registration process of registering the first mode,
the operation of the electronic device is controllable in the second mode between the communication terminal device and the electronic device which are associated with each other in advance by carrying out a registration process of registering the second mode,
in a case where the registration process of registering the second mode is carried out with respect to the communication terminal device and the electronic device,
the server device (i) receives a list of the electronic device which is associated with the communication terminal device in advance by carrying out the registration process of registering the first mode, the list being transmitted to the server device according to the second communication method by the communication terminal device, (ii) transmits, to the communication terminal device, according to the second communication method, selection request information for causing a user to select the electronic device from the list, and (iii), upon reception of the access from the electronic device selected on the basis of the selection request information by the user of the communication terminal device, registers the electronic device and the communication terminal device associated with each other as the combination of the communication terminal device and the electronic device which combination allows the operation of the electronic device to be controlled.
